(19) United States
(12) Patent Application Publication
(10) Pub. No.: US 2014/0246835 A1
(43) Pub. Date: Sep. 4, 2014

(54) COMPONENT

(71) Applicants: Frank Stiehler, Bad Liebenwerda (DE); Lars Schellhorn, Saalfeld (DE)

(72) Inventors: Frank Stiehler, Bad Liebenwerda (DE); Lars Schellhorn, Saalfeld (DE)

(73) Assignee: MTU Aero Engines AG, Munich (DE)

(21) Appl. No.: 14/237,810

(22) PCT Filed: Jul. 20, 2012
(86) PCT No.: PCT/EP2012/003078

§ 371 Date: May 16, 2014

(30) Foreign Application Priority Data
Aug. 9, 2011 (EP) 11176971.7

(51) Int. Cl. F16J 9/14; F16J 15/32; F16B 17/00

(52) U.S. Cl. CPC F16J 9/14; F16B 17/00; F16J 15/32
USPC 277/496; 403/375; 277/500

(57) ABSTRACT

A component is disclosed. The component includes a base body with a first end section and a second end section. The first end section has a first locking protrusion with a first guide surface and a first guide section with a first support surface. The second end section has a second guide section with a second guide surface and a second locking protrusion with a second support surface. The first guide surface is contactable with the second guide surface with respect to a guide plane and the first support surface is contactable with the second support surface with respect to the guide plane such that the first locking protrusion is engageable with the second locking protrusion in a locked position.

This application claims the priority of International Application No. PCT/EP2012/003078, filed Jul. 20, 2012, and European Patent Document No. 11176971.7, filed Aug. 9, 2011, the disclosures of which are expressly incorporated by reference herein.

### BACKGROUND AND SUMMARY OF THE INVENTION

The invention relates to a component, in particular a ring or rod component.

Components designed as damping rings, sealing rings, securing rings or piston rings of a machine, in particular of a turbo engine, such as an aircraft turbine, for example, are known in the general prior art. For example, damping rings are used in the compressor area of gas turbines. The end sections of the rings can move freely here in relation to one another.

German Patent Document No. DE 2 255 019 A1 also discloses sealing rings with locking of the end sections in the tangential direction. The ring ends here are pushed into one another axially and are thereby joined. Such sealing rings are secured axially in the installed position, based on engagement of the ring ends with the side walls of the annular groove.

One disadvantage of such components is that friction wear (English: fretting) and damage at the installation site as well as adjacent elements may occur due to vibration of end sections in particular. Another disadvantage is that the components can become loosened from their installed position because of pre-stressing, a lack of axial fixation or other effects.

Against this background, the object of the invention is to create a component which can be positioned reliably in its installed position and in which the wear and damage to elements in the region of the end sections of the component are at least reduced.

The component according to the invention is embodied as a ring or rod element, for example, and has a base body which in turn has at least one end section that can be connected to another end section. According to the invention, a first end section is provided with a locking protrusion which has a guide face that can be brought into engagement with a guide face of a guide section of the second end section with respect to a guide plane, such that the second end section has a locking protrusion with a support surface which can be brought into engagement with a support surface of a guide section of the first end section with respect to the guide plane, such that the locking protrusions engage with one another in a locking position. A form-fitting connection is thereby achieved, satisfying high demands of the connection. A plurality of components of a component array may be connected by at least one end section. The second end section here may be provided on an additional component, i.e., not on the first component. At least one component cannot be released from its installed position, for example, due to pre-stressing or other effects. Rings need not be secured at the periphery (for example, because of a window in the running surface). Wear and damage to the element with which the component is associated, such as a compressor rotor of an aircraft turbine, for example, as well as adjacent elements in the region of the end sections, for example, blade platforms of compressor blades, are at least greatly minimized because of the defined connection of the ends, such as ring ends, for example. The operational reliability is thereby substantially improved and a longer lifetime is achieved.

Because of the guided ring ends, a ring element such as a damping ring, for example, may be arranged to rotate freely in the annular groove. Furthermore, warping of the ring ends, with the associated wear phenomena and damage, is suppressed. In the case of components designed as damping rings, it is also advantageous that the damping behavior is essentially unchanged even in the region of the ring ends because the damping compound only undergoes minimal changes in the connecting area of the ring ends. Optimization of costs is therefore made possible on the whole because of the surroundings of the elements that are easily implemented.

According to the invention, it is preferred if a seating surface of the locking protrusion of the first end section can be brought into engagement with an engagement surface of the second end section with respect to a plane of contact. The end sections and/or closure ends of the component according to the invention are therefore guided with respect to the guide plane and the support plane, so that the relative movement of the end sections in relation to one another is defined in all degrees of freedom. Because of the form-fitting connection, the ends are preferably secured in the tangential plane and radially. The form-fitting connection may be embodied in such a way that through mirror imaging/symmetry of the form elements, for example, it is optimally adapted to the structural environment. The closure can be lockable, for example, by means of an additional element, such as a strap in the circumferential direction, for example, by bending the strap.

It has proven particularly advantageous if the guide plane forms an angle in the range of approximately 90° to the support plane. The guide plane may be designed according to the invention as an axial plane extending perpendicular to the axis of rotation of the ring in the case of a ring element. The support plane in the case of a ring element preferably extends as a tangential plane at an angle of 90° to the guide plane.

Components embodied as rod elements may have one or more curvatures. The ends of two rod elements may be joined together according to the invention.

According to a particularly preferred exemplary embodiment of the invention, the end sections of the component can be pivoted from an open position into one another to establish the locked position. The guide surfaces here can be brought into contact with the support surfaces by means of a pivoted movement. This permits easy assembly of the component without special tools.

The locking protrusions are preferably arranged one after the other in the circumferential direction and/or in the longitudinal direction of the base body, so that, in addition to the closing effect, a compact design is made possible.

In a preferred exemplary embodiment, the base body has an approximately rectangular cross section. The side faces of connected ends preferably extend in the same planes.

The end sections can preferably be displaced in the longitudinal direction of the component in a limited range relative to one another. The locking protrusions in the case of a ring element may form a stop here, which limits the maximum widening of the ring element in a defined manner.

In one embodiment of the invention, the longitudinal direction of the locking protrusions extends essentially parallel to the longitudinal direction of the guide sections. The extent of the longitudinal directions may be curved approximately in adaptation to the ring curvature in the case of a ring element in particular.

It is preferable according to the invention if the second end section has a bearing surface arranged adjacent to the locking protrusion, so that this bearing surface can be brought into contact with a sliding surface of the guide section of the first end section. In the closed state of the lock, the degrees of freedom of the connection are restricted in accordance with the requirements of the component.

The sliding surface of the first end section of the component is preferably arranged adjacent to its support surface such that the surfaces form an angle in the range of 90° to one another. The guide arrangement is therefore designed to be extremely compact.

The first end section of the component preferably has an application surface situated adjacent to the locking protrusion, this application surface being movable into contact with a bearing surface of the guide section of the second end section.

Functionally and with regard to the manufacturing technology, it is advantageous if the base body of the component is set back in steps relative to the bedding surface of the second end section. In the case of ring elements, the bedding surface of the second end section is preferably formed with stepwise radial setbacks.

Additionally or alternatively, the base body is preferably set back in steps toward the application surface of the first end section. This application surface is preferably formed with radially setback steps in the case of ring elements.

In a preferred embodiment of the invention, a gap is formed between the front surfaces of the guide sections in the locked position of the component. Additionally or alternatively, a gap may also be formed between the front surfaces of the locking protrusions and the base body. The end sections here are joined together in such a way that the component has overlapping regions that form guides and stops. On the whole, the end sections are therefore longitudinally displaceable relative to one another within a defined range.

In a preferred embodiment variant of the invention, at least one edge region of the component is provided with rounded edges, transitional radii and/or inclined faces. The inclined faces or rounded edges may be designed in such a way that the end section does not have any pointed edge contact with neighboring elements that would promote wear such as, for example, the base of a ring groove for receiving a damping ring. Wear and damage to the component and its contact partners are therefore further reduced or even prevented (preventing interactions).

The component according to the invention may advantageously be embodied as a damping ring, a sealing ring, a securing ring and/or a piston ring of a machine, preferably a turbo engine, such as an aircraft turbine, for example. The component is suitable in particular for shaft applications in a turbo engine, such as an aircraft turbine, for example.

Other advantageous refinements of the invention are part of the additional dependent claims.

A preferred exemplary embodiment of the invention is explained in greater detail below on the basis of schematic diagrams.

### BRIEF DESCRIPTION OF THE DRAWINGS

FIG. 1 shows a detailed diagram of a component according to the invention, designed as a damping ring, showing the region of the ring ends;

FIG. 2 shows a detailed diagram of the damping ring from FIG. 1 with an open closure;

FIG. 3 shows a detailed diagram of the damping ring from FIG. 1 with a closed closure;

FIG. 4 shows another detailed diagram of the damping ring from FIG. 1 with an open closure; and

FIG. 5 shows another detailed diagram of the damping ring from FIG. 1 with a closed closure.

### DETAILED DESCRIPTION OF THE DRAWINGS

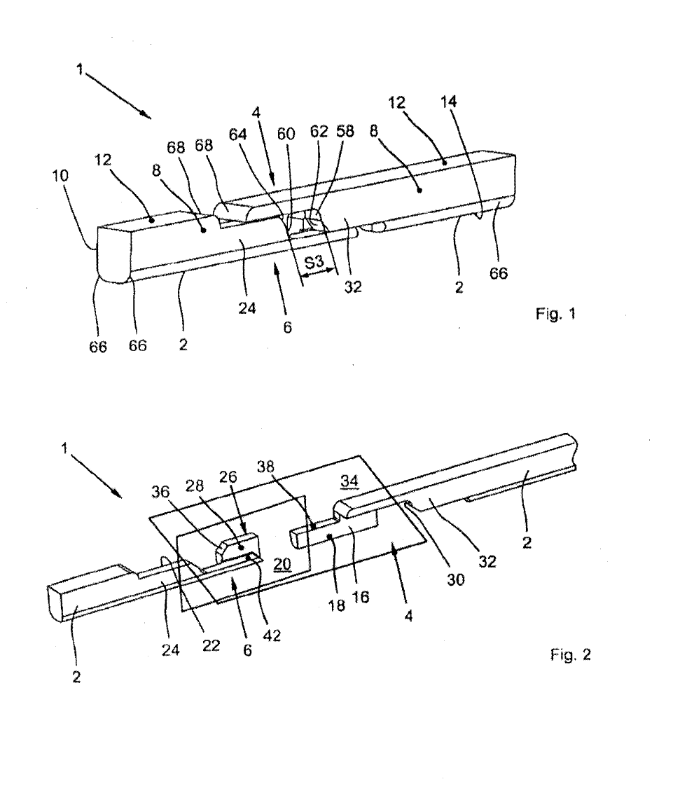

FIG. 1 shows as an example a component 1 according to the invention designed as a damping ring in a locked position, having a base body 2 with two interconnectable end sections 4, 6. The base body 2 has an approximately rectangular cross section, with side faces 8, 10, 12, 14 of the connected ends extending in the same planes. Such damping rings 1 are used in the region of a high pressure compressor of an aircraft turbine in particular.

As shown in particular in FIG. 2, which shows a detailed diagram of the damping ring 1 from FIG. 1 in its open position, a first end section 4 of the damping ring 1 is provided with a locking protrusion 16 which has a guide surface 18. The guide surface 18 can be moved into contact with a guide surface 22 of a guide section 24 of the second end section 6 with respect to a guide plane 20, which is indicated schematically (cf. FIG. 1). The second end section 6 has a locking protrusion 26 with a support surface 28, which can be moved into contact with a support surface 30 of a guide section 32 of the first end section 4 with respect to the guide plane 20. The longitudinal direction of the locking protrusions 16, 26 extends parallel to the longitudinal direction of the guide sections 24, 32. The locking protrusion 26 is provided with a bevel 36 on a front surface at a distance from the free end. The locking protrusions 16, 26 engage with one another in a locking position according to FIG. 1. The guide plane 20 forms an angle of approximately 90° to a support plane 34 and is embodied as a central axial plane extending perpendicular to the axis of rotation of the ring 1. The end sections 4, 6 and/or the closing ends of the damping ring 1 are therefore guided with respect to the guide plane 20 and the support plane 34, so that the movement of the end sections 4, 6 relative to one another is defined. The end sections 4, 6 of the damping ring 1 can be pivoted out of the open position shown here to establish the locked position according to FIG. 1. The guide surfaces 18, 22 can be moved thereby into contact by means of a pivoting movement. The support surfaces 28, 30 can also be brought into contact with one another by a pivoting movement. The guide sections 24, 32 supplement one another in width with the locking protrusions 16, 26 to form the total width, which corresponds essentially to the width of the base body 2. In the exemplary embodiment shown here, the guide sections 24, 32 are approximately the same width as the locking protrusions 16, 26.

Thus, on the whole, a form-fitting connection is achieved, which meets high demands of the connection. Wear and damage to the component with which the damping ring is associated, for example, with a compressor rotor of an aircraft turbine as well as adjacent elements in the area of the end sections 4, 6, for example, the blade platforms of compressor blades are at least greatly minimized because of the defined guidance of the ring ends 4, 6. The damping ring 1 can also be positioned to rotate freely in an annular groove (not shown here) because of the guided ring ends 4, 6. The damping ring 1 cannot become loosened from its installed position here during operation. This greatly improves operational reliability and yields a longer service life.

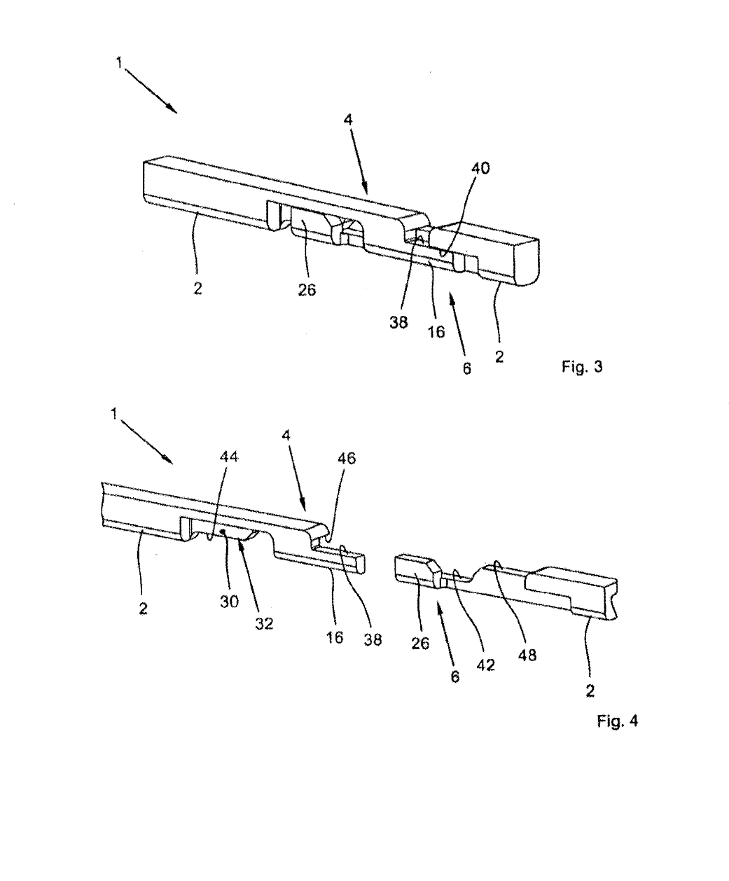

According to FIG. 3, which shows another detailed diagram of the damping ring 1 from FIG. 1, a seating surface 38 of the locking protrusion 16 of the first end section 4 is in contact with a contact surface 40 of the second end section 6 in the locked position of the closure. In the locked position, the locking protrusions 16, 26 are arranged one after the other in the circumferential direction and/or in the longitudinal direction, so that secure locking is made possible with a compact design. The end sections 4, 6 can therefore be displaced relative to one another within a defined limited range in the longitudinal direction.

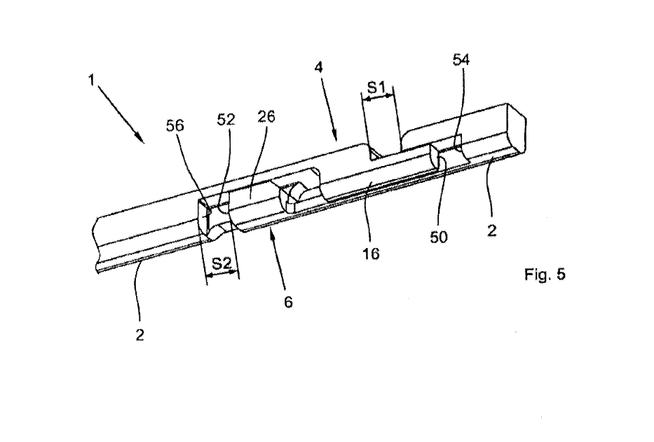

As shown in FIG. 4, which illustrates another detailed diagram of the damping ring 1 from FIG. 1 with the closure opened, the second end section 6 has a bedding area 42, which is situated adjacent to the locking protrusion 26 and which can be moved into contact with a sliding surface 44 of the guide section 32 of the first end section 4, the sliding surface being provided at the bottom radially. The sliding surface 44 is situated adjacent to its support surface 30 so that the surfaces 30, 44 form an angle of 90° to one another. The guide arrangement is therefore designed to be extremely compact. The first end section 4 also has an application surface 46, which is situated adjacent to the locking protrusion 16 and can be moved into contact with a bearing surface 48 of the guide section 24 of the second end section 6. The base body 2 of the damping ring 1 is set back radially in steps toward the bearing surface 48. Furthermore, the base body 2 is set back radially in steps toward the seating surface 38 of the first end section 4.

According to FIG. 5, which shows another detailed diagram of the damping ring 1, a gap S1, S2 is formed in the locked position between the front surfaces 50, 52 of the locking protrusions 16, 26 and surfaces 54, 56 of the base body 2.

As shown in FIG. 1 in particular, a gap S3 is also formed between the front surfaces 58, 60 of the guide sections 24, 32 of the ring ends 4, 6 arranged adjacent to one another. The front surfaces 58, 60 are provided with bevels 62, 64, so that frictional wear is minimized in this region. The end sections 4, 6 are connected to one another in such a way that the damping ring 1 has overlapping regions forming guides and stops. On the whole, the end sections 4, 6 are longitudinally displaceable in relation to one another within a defined range. A region of the damping ring 1 on the groove end on the inside radially is provided in the edge region with rounded edges 66, which are also formed in the region of the end sections 4, 6 in addition to the base body 2. The rounded edges 66 are designed so that the end sections 4, 6 do not have any pointed wear-promoting edge contact with neighboring elements such as, for example, the base of an annular groove to receive the damping ring 1. End edges of the base body in the region of the end sections are therefore also provided with rounded edges 68. Wear and damage to the damping ring 1 and to its contact partners are therefore further reduced and/or prevented.

The invention is not limited to such damping rings 1 and instead the components may advantageously be used as ring-shaped or rod-shaped, straight or curved components for other applications.

A component 1, in particular a ring element or rod element having a base body 2, which in turn has at least one end section 4 that can be connected to another end section 6, is disclosed, a first end section 4 having a locking protrusion 16 with a guide surface 18 which can be moved with respect to a guide plane 20 into contact with a guide surface 22 of a guide section 24 of the second end section 6, and the second end section 6 has a locking protrusion 26 with a support surface 28, which can be moved with respect to the guide plane 20 into contact with a support surface 30 of a guide section 32 of the first end section 4, such that the locking protrusions 16, 26 engage with one another in a locked position.

### LIST OF REFERENCE NUMERALS

1 Component

2 Base body

4 End section

6 End section

8 Side face

10 Side face

12 Side face

14 Side face

16 Locking protrusion

18 Guide surface

20 Guide plane

22 Guide surface

24 Guide section

26 Locking protrusion

28 Support surface

30 Support surface

32 Guide section

34 Support plane

36 Bevel

38 Seating surface

40 Contact surface

42 Bedding area

44 Sliding surface

46 Application surface

48 Bearing surface

50 Front surface

52 Front surface

54 Surface

56 Surface

58 Front surface

60 Front surface

62 Bevel

64 Bevel

66 Rounded edge

68 Rounded edge

1.-12. (canceled)

13. A component, comprising:
a base body with a first end section and a second end section;
wherein the first end section has a first locking protrusion with a first guide surface and a first guide section with a first support surface;
wherein the second end section has a second guide section with a second guide surface and a second locking protrusion with a second support surface;
wherein the first guide surface is contactable with the second guide surface with respect to a guide plane and wherein the first support surface is contactable with the second support surface with respect to the guide plane such that the first locking protrusion is engageable with the second locking protrusion in a locked position.

14. The component according to claim 13, wherein the component is ring-shaped or rod-shaped.

15. The component according to claim 13, wherein a seating surface of the first locking protrusion of the first end section is contactable with a third support surface of the second end section with respect to a support plane.

16. The component according to claim 13, wherein the first and second end sections are pivotable from an open position into the locked position.

17. The component according claim 13, wherein the first and second locking protrusions in the locked position are arranged one after the other in a circumferential direction and/or in a longitudinal direction of the base body.

18. The component according to claim 13, wherein the guide plane is an axial plane.

19. The component according to claim 13, wherein a longitudinal direction of the first and second locking protrusions and/or of the first and second guide sections runs essentially parallel to one another.

20. The component according to claim 13, wherein the second end section has a bedding area arranged adjacent to the second locking protrusion which is contactable with a sliding surface of the first guide section of the first end section.

21. The component according to claim 20, wherein the sliding surface is arranged adjacent to the first support surface and wherein the sliding surface and the first support surface form an angle in a range of approximately 90°.

22. The component according to claim 13, wherein the first end section has an application surface arranged adjacent to the first locking protrusion which is contactable with a bearing surface of the second guide section of the second end section.

23. The component according to claim 22, wherein the base body is set back radially in steps toward the bearing surface.

24. The component according to claim 13, wherein a gap is formed between respective front surfaces of the first and second guide sections and/or gaps are formed between respective front surfaces of the first and second locking protrusions and the base body in the locked position.

25. The component according to claim 13, wherein the component is a damping ring, a sealing ring, a securing ring or a piston ring of a turbo engine.

26. The component according to claim 25, wherein the turbo engine is an aircraft turbine
